(19) United States
(12) Patent Application Publication
(10) Pub. No.: US 2020/0092468 A1
(43) Pub. Date: Mar. 19, 2020

(54) MULTI-RANGE IMAGING SYSTEM AND METHOD

(71) Applicant: UMECH TECHNOLOGIES, LLC, Watertown, MA (US)

(72) Inventors: Michael Mermelstein, Cambridge, MA (US); Charles Cameron Abnet, Waltham, MA (US)

(73) Assignee: UMECH TECHNOLOGIES, LLC, Watertown, MA (US)

(21) Appl. No.: 16/572,406

(22) Filed: Sep. 16, 2019

Related U.S. Application Data
(60) Provisional application No. 62/731,205, filed on Sep. 14, 2018.

(51) Int. Cl. H04N 5/232; H04N 5/225; G06T 5/00; G06T 5/50

(52) U.S. Cl. CPC H04N 5/23229; H04N 5/2254; H04N 5/2256; G06T 2207/20208; G06T 5/009; G06T 5/50; H04N 5/23216

(57) ABSTRACT

In part, the disclosure relates to an imaging system that includes a control system; image sensors in electrical communication with the control system, the one or more image sensors support data collection relative to a first pixel subwindow; and an optical assembly, the optical assembly oriented to receive light from the target and direct the light to the image sensor; wherein the optical assembly has an imaging focal volume within the imaging environment that spans a range of focus. The timing system is in electrical communication with the one or more image sensors, an illumination system and a translation assembly. A translation assembly may move target in imaging environment. The timing systems triggers illumination system to illuminate the target and the one or more sensors to image the target when image sensor pixel values in the first pixel subwindow align with at least a portion of the target.

### RELATED APPLICATIONS

This application claims the benefit of priority under 35 U.S.C. 119(e) from U.S. Provisional Application Ser. No. 62/731,205 filed on Sep. 14, 2018, the disclosure of which is herein incorporated by reference in its entirety

### BACKGROUND

Imaging moving targets often yields unsatisfactory results. This may occur as a result of motion blur, exposure time, and other imaging artifacts that may result from the speed of the object, lack of lighting controls and other factors. Generally, it is easier to image large objects and slower moving objects. In contrast, when imaging smaller and faster moving objects additional challenges arise.

In part, the present disclosure provides various technical solutions to specialized instances when imaging moving objects is of interest. In particular, small objects that are moving in environments in which optical lighting and imaging controls are lacking. The present disclosure addresses these challenges and others.

### SUMMARY

In part, the disclosure relates to methods and systems for imaging one or more targets including moving targets and generated combined or composite images from multiple images of the one or more targets to compensate for undesirable light conditions and other factors, such as variations in height of components of target or dissimilar optical properties, that would prevent or interfere with imaging the one or more targets.

In one aspect, the disclosure relates to an imaging system. The imaging system may include a control system. In turn, the control system may include a timing system and an image processing system. The timing system may include one or more microprocessors, busses, encoders, switches, triggers, and other components to control a light source, a translation assembly, such as a conveyor, and other electrical and mechanical subsystems. The control system may include one or more computing device, FPGAs, microprocessors, circuits, ASICs, software-based systems, and combinations thereof. The one or more image sensors are in electrical communication with the control system. Further, the one or more image sensors support data collection relative to a first pixel subwindow of a given image sensor. The imaging system may include an optical assembly positioned between the one or more image sensors and a target, the optical assembly oriented to receive light from the target and direct the light to the image sensor. The optical assembly has an imaging focal volume within the imaging environment that spans a range of focus.

In one embodiment, the timing system in electrical communication with the one or more image sensors, an illumination system and a translation assembly. As a result, the imaging systems can be used with third party illumination, translation, and timing systems in some embodiments. In one embodiment, the translation assembly moves target in imaging environment. Further, the timing systems is programmed and/or configured to triggers the illumination system to illuminate the target. In one embodiment, the one or more sensors receive an image of the target. In one embodiment, the first pixel subwindow is aligned with at least a portion of the image of the target. Triggering the one or more sensors to image the target may include triggering a shutter or other device that prevents the sensors from imaging until the shutter or other device is activated, such as by the timing system.

In one embodiment, image processing system synthesizes a 2D image from at least one frame exposure that includes the image sensor pixel values readout from the one or more image sensors. In one embodiment, the control system further includes a control interface, wherein the control interface accepts user inputs to define a first pixel subwindow. In one embodiment, the optical assembly is telecentric. The system may further include at least a second pixel subwindow wherein the optical assembly is configured to provide telecentric imaging of at least the imaging focal volume the pixel value processor synthesizes at least a second 2D image from image sensor pixel values in the second pixel subwindow.

In one embodiment, a plurality of frame exposures are acquired with respect to the target using the image system, wherein the pixel value processor synthesizes at least a first 2D image from a first subset of the frames and a second 2D image from a second subset of the frames, wherein the timing system coordinates frame exposures in response to motion of the target such that image sensor pixel values in the pixel subwindow align cyclically with pixels in each of the 2D images

In one embodiment, the timing system uses one or more of illumination, exposure, and translation parameters chosen for each of the 2D images. The system may further include a projection system includes a projection focal volume such that the imaging focal volume and the projection focal volume overlap. In one embodiment, the projection system projects a predetermined pattern uniquely encoding target height. In one embodiment, the target provides light from a least one fluorescent label in response to a least one component wavelength of received light. In one embodiment, the targets range from 1 mm to about 10 mm along one or more dimensions, wherein targets are imaged while traveling at rate that ranges from about 10 mm/second to about 2,000 mm/second. In one embodiment, targets are imaged while traveling at rate that ranges from about 100 mm/second to about 20,000 mm/second. In one embodiment, targets are imaged while traveling at rate that ranges from about 1,000 mm/second to about 200,000 mm/second. In one embodiment, targets are imaged while traveling at rate that is greater than about 200,000 mm/second.

For example, a microscopic target e.g. blood cell with dimensions on the order of about 10 microns may be imaged while traveling from between about 1 micron/sec to about 1 mm/sec. This implementation may be in a fluid flow or on a slide fixed to a moving microscope stage. In various embodiments, the rate of target movement or fluid flow are in a range suitable for imaging such a microscopic or small scale target as part of a fluidic chip device, system on a chip device, and flow cytometry devices.

Various rates of speed for a given target can be imaged, but vary as targets become microscopic (blood cells, etc.) or very large (cars, airplanes, celestial bodies, etc.) or as distances change between imaging system and target. The targets may move, oscillate, vibrate, translate in space, grow, shrink, remain stationary or undergo other changes or periods of no change in various embodiments.

The system may further include one or more sensors arranged relative to target and in communication with the control system, wherein the one or more sensors measure changes in height of the target, wherein data from the one or more sensors is used to compensate for target height variations. In one embodiment, the optical assembly is positioned such that image plane relative to the target intersects a motion axis of the target. The system may further include an illumination system includes an illumination source, the illumination system includes one or more illumination system parameters. In one embodiment, the illumination system parameters are selected from a group consisting of duration, angular content, direction, shutter speed, polarization, coherence, and spectral content.

In another aspect, the disclosure relates to a method of imaging a target undergoing relative motion to a reference frame. The method may include one or more of positioning an image sensor relative to the target and reference frame, wherein the image sensor generates image sensor pixel values, the target moving along a first axis; specifying a pixel subwindow for the image sensor corresponding to a subset of image sensor pixel values; positioning an imaging optical assembly having an image plane relative to the target such that the image plane intersects the first axis at an angle such the pixel subwindow is alignable with one or more of a plurality of regions in the reference frame transverse to the translation axis, wherein the plurality of regions corresponds to a focal height; synchronizing illuminating and imaging of target with respect to the pixel subwindows, such that illumination and imaging occur when one or more of the plurality of regions align with the pixel subwindow; and imaging portions of the target disposed in at least one of the regions as the target translates through said image plane and collecting image data with respect thereto.

In one embodiment, the method further includes parsing the image data into groups according to corresponding to pixel subwindow data and illumination exposure conditions. In one embodiment, the method further includes specifying different illumination schemes to expose at least one portion of the target with differing illumination schemes wherein the schemes include illumination parameters chosen from the group consisting of duration, angular content, direction, polarization, coherence, and spectral content.

In one embodiment, the method further includes collecting a plurality of synchronized image data at identical target locations and under identical exposure conditions during a single translation of the target. In one embodiment, the method further includes assembling at least one 2D image from the synchronized image data. In one embodiment, the method further includes combining subwindow data from each image data group to form a combined image of the target where each portion of the target is in focus. In one embodiment, the combined image is a planarized image.

In one embodiment, the target is at least one object moving in a fluid flow channel and further includes specifying a subpixel window for one or more positions along the flow channel. In one embodiment, the method further includes combining subwindow data from each image data group to form a combined image wherein contrast of regions of interest having dissimilar optical properties are enhanced such that contrast of combined image does not change more than between about 10% and 20% across the image. In one embodiment, the contrast changes less than between about 5% to about 10% across the image.

In part, the disclosure relates to an imaging system. The imaging system may include an image sensor comprising at least one pixel subwindow; an illumination system including an illumination source; a target providing light in response to the illumination system; an optical assembly positioned to cast an image of the target onto the image sensor and possessing optical parameters including an imaging focal volume that spans a range of focus; a control interface usable to select parameters of the image including at least the position of the pixel subwindow on the image sensor corresponding to a desired portion of the range of focus; a translation assembly providing motion of the target relative to the imaging focal volume; an image sensor timing system that coordinates the timing of at least one frame exposure of the pixel subwindow with the target illumination and the translation assembly such that image sensor pixel values in the pixel subwindow align with at least a portion of the target; and a pixel value processor to synthesize a 2D image from at least one frame exposure including the image sensor pixel values.

In one embodiment, the illumination system parameters are selected from a group including duration, angular content, direction, polarization, coherence, and spectral content. In one embodiment, the system further includes at least a second pixel subwindow wherein the optical assembly is configured to provide telecentric imaging of at least the imaging focal volume the pixel value processor synthesizes at least a second 2D image from image sensor pixel values in the second pixel subwindow.

In one or more systems or methods, a plurality of frame exposures are acquired; the pixel value processor synthesizes at least a first 2D image from a subset of the frames and a second 2D image from a different subset of the frames; and the image sensor timing system coordinates frame exposures in response to the motion such that image sensor pixel values in the pixel subwindow align cyclically with pixels in each of the 2D images. In one embodiment, the image sensor timing system uses illumination, exposure, and translation parameters chosen for each of the 2D images. In one embodiment, the system further includes a projection system having a projection focal volume such that the imaging focal volume and the projection focal volume overlap. In one embodiment, the projection system projects a predetermined pattern onto the target in the imaging focal volume such that the predetermined pattern overlaps portions of the target and subsequent imaging of the portions uniquely encodes the height of the portions. In one embodiment, the target provides light from a least one fluorescent label in response to a least one component wavelength of the illumination source.

In part, the disclosure relates to a method for collecting 2D image data of a target. The method may includes one or more providing a translating target having at least one translation axis; providing an illumination system including an illumination source; positioning an imaging optical assembly having an imaging sensor such that the image plane of the assembly intersects with the translation axis at an angle such that subwindows of the image sensor correspond to stripes of space transverse to the translation axis where each stripe maps to a focal height and depth of focus; providing a timing system to synchronize the translation of the target, the illumination scheme from the illumination system, and exposure of the imaging sensor with predetermined subwindows; collecting synchronized image data as the target translates through the image plane; and parsing the image data into groups according to appropriate subwindows and exposure conditions.

In one embodiment, the method may include timing of a plurality of different illumination schemes to expose at least one portion of the target with differing illumination schemes wherein the schemes include illumination parameters chosen from the group including duration, angular content, direction, polarization, coherence, and spectral content. In one embodiment, the method may include collecting a plurality of synchronized image data at identical target locations and under identical or similar exposure conditions during a single translation of the target.

Although, the disclosure relates to different aspects and embodiments, it is understood that the different aspects and embodiments disclosed herein can be integrated, combined, or used together as a combination system, or in part, as separate components, devices, and systems, as appropriate. Thus, each embodiment disclosed herein can be incorporated in each of the aspects to varying degrees as appropriate for a given implementation.

### BRIEF DESCRIPTION OF THE DRAWINGS

The figures are not necessarily to scale, emphasis instead generally being placed upon illustrative principles. The figures are to be considered illustrative in all aspects and are not intended to limit the disclosure, the scope of which is defined only by the claims.

FIG. 1 is a schematic view of a multi-range imaging system with a focal plane tilted relative to the motion axis of a target according to an embodiment of the disclosure.

FIG. 2 illustrates the correspondence between imaged portions of a target and pixel subwindows on an image sensor across time according to an embodiment of the disclosure.

FIG. 3 illustrates stitching together pixels of subwindows to form a larger 2D image having an effective focal height and depth of focus according to an embodiment of the disclosure.

FIG. 4 illustrates the stitching of pixel subwindows from two sensor locations to form two 2D images with different focal height according to an embodiment of the disclosure.

FIG. 5 illustrates a time sequence of collected image frames demonstrating three-fold multiplexing according to an embodiment of the disclosure.

FIG. 6a illustrates a sequence of camera exposures of constant duration according to an embodiment of the disclosure.

FIG. 6b illustrates a sequence of camera exposures of differing duration according to an embodiment of the disclosure.

FIG. 6c illustrates an exposure and illumination strategy using different exposure durations and multiple lamps and lamp intensities according to an embodiment of the disclosure.

FIGS. 7a and 7b are schematic diagrams of target cross-section illuminated by lamps having different angular content that illustrate an example of multiplexing used to improve contrast of target features according to an embodiment of the disclosure.

FIG. 8 illustrates different cases of the relative timing of an image sensor's shutter and illumination according to an embodiment of the disclosure.

FIG. 9 illustrates the operation of portions of the multi-range imaging system during the imaging of multiple regions of interest in a target scene according to an embodiment of the disclosure.

FIG. 10 is a schematic view of a multi-range imaging system incorporating confocal pattern projection to encode target height information according to an embodiment of the disclosure.

FIG. 11 illustrates an arrangement of mirrors capable of image portions of a target from eight directions with a single imaging system orientation according to an embodiment of the disclosure.

FIG. 12 is a flow chart depicting an exemplary imaging method using subwindows according to an embodiment of the disclosure.

FIG. 13 is a series of images of an imaged target that includes various components that have been obtained according to different imaging methodologies including those of the disclosure.

### DETAILED DESCRIPTION

Making an in-focus photograph of a moving target presents many technical challenges. In particular, there is a well-known trade-off between the brightness of the imaging optics and the depth of field in the target space. Furthermore, focusing on target features at different heights can require mechanical actuation that can limit the practical speed of imaging. Nonetheless, there are many applications of photographing a moving target. These include assembly line-based manufacturing, objects moving in or disposed in a moving fluid, vibrating and/or oscillating objects, and numerous other examples spanning any a wide range of industries. Therefore, one motivation of the disclosure is to provide technical solutions to various problems of photographing a moving target with a bright image, in good focus at the heights of target features of interest, with no moving parts used in actuating focus between those heights. An example of the moving parts that are avoided may include actuators and/or mechanical systems for varying positions of compound lens or other optical elements of a focusing system.

Moreover, it is often desirable to collect, transmit, and process imagery of a moving target as quickly as possible. Thus, a further motivation of the disclosure is to provide a highly efficient system for such imaging work—one that provides a sufficiently bright, in-focus image with a high imaging throughput, while collecting, transmitting, and processing a minimum of image data. In some embodiments, the technical solutions benefit from the use of subset of imaging data obtained relative to a set of imaging data, such as for example a window or subset of pixel data obtained relative to a larger set of pixel data.

Additionally, in some cases, human visual interpretation as well as machine vision analysis of photographs can benefit from “subject isolation” resulting from an in-focus subject on a blurry background. Therefore, an additional motivation of the disclosure is to capture photographs of targets that emulate and/or include a pre-defined focal plane and the contrast of in-focus and out-of-focus features in the captured image.

Finally, it is often useful to provide more than one view of a scene, for example, at multiple focus heights, with multiple lighting conditions, or with different exposure conditions. Thus, yet another motivation for the disclosure is to provide multiple simultaneous images of the same feature on a moving target, each such simultaneous image includes usefully differing image data. For example, a multi-component object, such as circuit board with height varying components, undergoing transport and/or manufacture at different production, diagnostic or testing stages can be imaged using one or more light sources and imaging devices that are controlled and time managed to obtain a time series of the same or different components of the object. Objects assembled, tested, and transported at a given speed/rate of motion using an assembly, conveyor, or other transport mechanism can be imaged in a multitude of differing scenarios to obtain multiple sets of image data. Such sets of image data can include selections of pixel data in the form of windows, subsets of pixel data, to further facilitate imaging, correlating, cross-correlating, combing, adding, subtracting, and otherwise using the imaging data in the aggregate or in grouping to enhance and improve component imaging on an expedited basis. In one embodiment, a pixel subwindow or a pixel window may refer to the region of the imaging sensor corresponding to a set of imaged pixels and/or the image data collected or read out with respect to a particular subset or window of such an imaging sensor.

### Advantages Over Contiguous 3D Volume Imaging Systems

In many applications, it is desirable to overlay and compare 2D images, for example, those from different focus heights. Such processing is simplified if the 2D images are aligned and sampled on the same pixel grid or relative to the same array of a combination of pixel grids. One advantage of the disclosure is this alignment. In general, interpolation is undesirable in image stitching, and a major advantage of the disclosure is a combination of techniques that obviates the need for interpolation. This provides high efficiency in image data collection, transmission, and processing, and naturally sharp imagery with no degradation from interpolation. In general, various embodiments of the disclosure are directed to systems and methods that avoid or operate in the absence of or without having to resort to using interpolation, mechanical actuation of focusing systems, such as electromechanically camera optics/autofocusing/focusing systems and related methods. Thus, interpolation-free image analysis, and autofocus-free or set focus systems and methods are used in various embodiments and combinations thereof.

Various legacy systems capture a contiguous 3D volume of image data from which, in principle, one can cull 2D image slices, such as still frames from a stream of video frames. In such a case, sample voxels are arranged in a 3D space on a different grid than the final images. Thus, telecentricity was not a critical requirement in those systems. However, when the sample voxel grid differs from the desired 2D image synthesis grid, 2D image synthesis requires interpolation between voxel locations. Interpolation leads to a loss of detail in the original image data, so, in such systems, the synthesis of a sharp 2D image at a given pixel pitch requires a degree of oversampling of the voxel grid, for example, oversampling by a Nyquist factor. Various embodiments of the disclosure benefit from using one or more telecentric illumination and/or telecentric lens systems. The disclosed systems and methods support one or more of constant/consistent magnification of objects in imaging environment, constant/consistent illumination in imaging environment, collimated and parallel redirection of one or more light rays relative to a given object or from a given light source, and others as disclosed herein.

In light of the foregoing summary points, various embodiments disclosure combines and integrates one or more or all of the following: (1) an imaging system with a telecentric object space, such as a telecentric lens, so that target features pass the same number of pixels over the image sensor surface even if these features are at different focal heights, (2) image frame capture synchronized or triggered with the passing of these features over the image sensor (e.g. timed with the stage position/spatial region of imaging platform/environment coordinate system), and (3) selectively generating or culling image data obtained from imaging device, such as an image sensor chip/line camera, using pixel subwindows. The combination of these techniques results in a massive improvement over legacy collection, transmission, and processing efficiency for the synthesis of 2D frames at one or more focus heights.

Using pixel subwindows greatly reduces the amount of image data captured and transmitted by the image sensor compared with a full-frame readout. In general, if an imaging sensor includes a U by V array of data collection elements, various spatial imaging subsets can be defined relative thereto such as one or more A by B arrays, wherein A is less than U and/or B is less than V. This can be visualized as a set of smaller rectangles (or strips) within a larger rectangle (strip) of the image sensor. The data collection elements of the image sensor map to pixels according to some scheme such as 1:1 scheme. As a result, for the pixels captured for a given image/image frame, in one embodiment only a subset also referred to as a pixel subwindow are used such as readout for image processing/image generation. In one embodiment, all of the image sensor data is generated when imaging but only the pixel subwindow data is readout, collected, extracted, used and/or stored and the other data is treated as extraneous and ignored—effectively it is not processed, which would be the case for a full image frame readout. In other embodiments, if the imaging sensor supports selective image capture with its data collection elements, only the image data corresponding to a given pixel subwindow is captured during imaging and thus it is the only data used.

In one embodiment, multiple image sensors can be used such as a first image sensor, a second image sensor, a third image sensor, a fourth image sensor, etc. These image sensors can be arranged in various spatial configurations. In one configurations, multiple image sensors are arranged at different heights and one or more subpixel windows of each respective sensor are alignable with height varying positions of a moving target of interest. When the target of interest passes the multiple image sensors, various components of the target having different heights align with the different sensors at the different subpixel windows for the image sensors and receive image data as a result of rays/portions of an image forming on such sensors.

Since image data are transmitted over time, greatly reducing the amount of image data also greatly reduces the amount of time needed to transmit the data. Thus, a high frame rate is made feasible with a small number of small pixel subwindows. For example, a pixel subwindow of about 52,000 pixels contains just about 10,000 pixels, or 1/500th of the number of pixels in a 5 megapixel image sensor. Supposing the image sensor is capable of about 100 fps with a full-frame readout, using the subwindow described above would allow about 500 times greater frame rate, or about 50,000 fps—a frame every about 20 microseconds.

In a given implementation, for imaging a moving objected relative to an image sensor, one or more pixel subwindows are pre-configured relative to one or more image sensors based on the type of object being imaged and its anticipated relative position with regard to the image sensor, and the pixel subwindow in particular. Thus, if bars of a material are being manufactured and transmitted through an imaging environment including one or more systems disclosed herein, if manufacturing defects arise on the front face or middle upper right region of the bar, based on prior studies of where defects/know failure modes are expected, the pixel subwindows are set such that they correspond with the anticipated target regions for defects and image data is only obtained with regard to those target regions of the moving object. This can be achieved using a user interface that maps selected image regions to controls that specify the pixel subdwindows for data capture/data read out.

### Narrow Pixel Subwindow Advantages Over Line-Scan Imaging

Line scan cameras take this principle to the limit by providing a frame with just 1 pixel in width and K frames in length, wherein K is greater than or equal to 1. In one embodiment, a pixel subwindow has a width of 1 and a length less than K. Supposing an equal read-out bandwidth with the example camera discussed above, a K=12000 pixel line-scan imager can capture frames five times faster: 250,000 fps, which is a frame every 4 microseconds. In some embodiments, the sensors used are line scan cameras.

In one embodiment, image data are collected at the same rate (in pixels/second) regardless of the number of pixels in the frame. A wider pixel subwindow results in a greater peak-to-peak deviation in focus from an ideal horizontal plane. Moreover, this deviation erodes the effective depth of field remaining in the setup. As a result, this deviation is avoided by using a line-scan image (1-pixel-wide pixel subwindow), in various embodiments.

In various embodiments, additional imaging parameters are evaluated and implemented for use in a given imaging system or method. The frame rate typically limits the maximum exposure time for collecting light. Extending the examples above, with a frame every 20 microseconds a given implantation can have an exposure time of 20 microseconds, but with a frame every 4 microseconds, the maximum is likely to be 4 microseconds. Depending on the target's brightness, the extra available exposure time could be required in a compromise of brightness vs. motion blur. In various embodiment, the scale units for evaluating various targets may range from minutes, seconds, fractions of a second, microseconds, and any other suitable time scale for a given embodiment.

Moreover, in the case of a lamp illuminating the target, with frames exposed for 4 microseconds, in the line scan case, the lamp must be on 100% of the time, but in the case of 4 exposure microseconds within a 20 frame time, a 20% duty cycle can be used, allowing greatly reduced power consumption by the lamp, greatly reduced heat in the lamp, and therefore possibly allowing a higher peak power driven into the lamp resulting in brighter imagery, which is often desirable.

Thus, given a combination of constraints describing the target features, desired exposure time, relative motion speed, magnification, resolution requirements, and so on, there are preferred or optimized pixel subwindows such as preferred lengths, widths, and orientations in accordance with the disclosure that is advantageous over prior art solutions. In various embodiments, the dimensions of a given pixel subwindow are selected to correspond with regions of interest of objects being imaged such as structures having varying heights or other features of interest. In some embodiments, the width of a given pixel subwindow may ranges from 1 to about 5 pixels. In some embodiments, the width of a given pixel subwindow may ranges from about 1 to about 3 pixels. In one embodiment, the length of a given pixel subwindow may include the length of pixels for the image sensor. Thus, for an image sensor of 4096 pixels in length with a width of 32 pixels, some of the pixel subwindows may be 1, 2, 3, 4, 5 (or more pixels) by about 4096 pixels. In other embodiments, less than about 4096 pixels of the length are used/readout for data analysis and image processing/parsing. In one embodiment, width of the pixel subwindow is correlated with tilt angle used for image plane, camera, or other tilted components of systems.

### Predetermined Pixel Subwindows

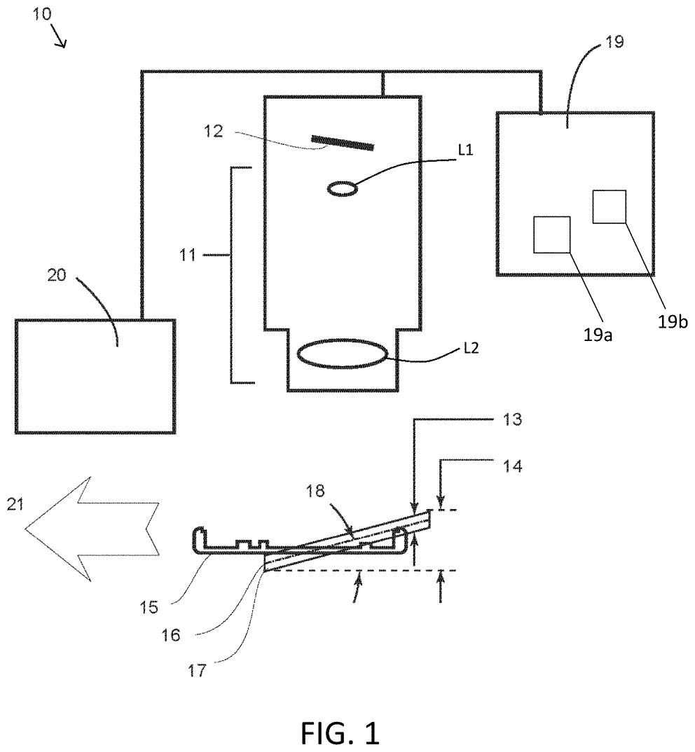

An advantage of the disclosure is the predetermination of pixel subwindow locations from foreknowledge of the imaging setup and measurement goals. For example, referring to FIG. 1, during system configuration the focal planes for achieving 2D images of the target's features are determined by inspection/calibration. In turn, the focal plane positions and/or relative distances are encoded or stored in the system as preset values. These can be configured by a user interface when implementing a given target specific implementation. Specific regions of interest on the target to image at predetermined focal heights can be user specified or selected from preset values from one or more user interfaces. From these specifications, the pixel subwindows can be set up for the one or more cameras, line cameras, and/or imaging devices being used to image one or more targets and the respective features thereof.

In contrast, culling in-focus content from frames of image data is an existing approach. However, determining the portion of image data to keep requires collecting and transmitting extra data beyond what is kept, and the processing of image data to determine in-focus portions is costly in time or power or hardware expense. Therefore, the disclosed systems and methods, which avoid these approaches, provide clear advantages.

### Dynamic Tracking

In some cases, targets will be presented at unknown heights. For example, targets moving on a conveyor belt might be a bit higher or lower, depending on vibrational modes in the belt. The height of the belt can be monitored with a laser height gauge or other metrology tool. These measured height various can be inputs for a control system to allow the imaging system to react dynamically to these and other imaging environment parameters that are measurable which contribute or cause variations in target height. Similarly, targets on the conveyor could be arranged with offsets in their in-plane positions. These shifts can also be monitored with a laser ranging gauge and other measurement devices or sensors oriented in the plane of the belt.

Accordingly, in various embodiments, one or more sensor or detections systems for measuring a position offset of the target can be used along or in combination with pixel subwindow predetermination during system configuration/calibration. A height offset of a tilted focal plane is equivalent to a linear shift of the pixel subwindows across the image sensor. An in-plane offset maps to a linear shift on the image sensor in the dimension across the axis of relative motion, or a timing offset for target shifts along the axis of motion. Therefore, in another embodiment of the disclosure, a position offset sensor is provided. As a result, such an offset sensor facilitates shifting a coordinate of the pixel subwindows from the reference position at which such windows were predetermined. This shifting may be implemented using the offset position from the position sensor as an origin or reference frame. Furthermore, the step of timing image acquisition can be provided in coincidence with a given moving target's arrival, in response to a position sensor. These and all of the other sensors and detectors disclosed herein can be in electrical or wireless communication with a control system that manages one or more or all of the imaging system components implemented for a given imaging environment.

### Simultaneous 2D Imaging at Multiple Heights

There are various problematic imaging scenarios that one or more embodiments are adapted to address. An imaging system with a range of focus much greater than its depth of field may be used or required for some imaging projects. Further, a target with features arranged in a diversity of heights beyond a single depth of field may be the subject of the imaging project being implemented using the systems and methods of the disclosure. In addition, as a further constraint some imaging projects necessitate forming in-focus images of these features in a single pass of the target through a focal volume or imaging environment.

Some CMOS image sensors may be configured or connected to read out multiple pixel subwindows per frame. In an embodiment, an image sensor is used to read out the two pixel subwindows. The image data from the subset of the sensor corresponding to the two subwindows can be juxtaposed and/or used to merge image data from each of the pixel subwindows in sequential frames. FIG. 4 shows multiple pixel subwindows simultaneously form images at multiple focus heights. As shown in FIG. 4, an image sensor is used to read out the two pixel subwindows. As shown, the system juxtaposes and merges image data from each of the pixel subwindows in sequential frames.

It is advantageous for the magnification at these two heights to be substantially equal, so that the target moves through the same number of pixels at each height. Therefore, in accordance with the disclosure, it is desirable for the imaging system to be sufficiently telecentric throughout the focal volume. This can be achieved by using one or more telecentric lens and/or telecentric light sources. In one embodiment, sufficiently telecentric or telecentric sufficiency refers to one or more of depth of focus or magnification of targets not changing within a given output image of the imaging systems or within a spatial domain such as a 2D subset of the imaging environment. In various embodiments, it is advantageous to have constant magnification with regard to one or more targets because this facilitate direct metrology of the targets and their components without a need to compensate for different levels of magnification in different parts of a given image or with regard to different targets in the image. Direct metrology allows for imaged targets to be used for measurements and other measurement-based calculations and analysis that are correlated with dimensions of actual targets being imaged.

While the imaging system of the disclosure is well suited to imaging a target object moving on a mechanical translation stage, the imaging system is equally suited to other mounting arrangements and other targets. For example, the imaging system can be mounted and translated past a stationary object as well as observing targets moving via fluid transport or other locomotion. Thus, the disclosure is not limited to imaging targets translated via stage. In general, the systems and methods disclosed herein are suitable for imaging various targets without limitation.

FIG. 1 schematically illustrates a multi-range imaging system 10 suitable for imaging one or more targets. The system 10 includes an optical assembly 11, preferably capable of telecentric imaging, at least one image sensor 12, an illumination source 20, a target 15 moving on a motion axis 21, for example a mechanical stage or within an imaging environment, and a control system 19. The control system can be implemented using a processor-based device such as a computing device. The control system can also include a timing system/subsystem 19a. In one embodiment, the control system orchestrates timing of image acquisition, illumination, and target motion. The interface of the control system may also be used to define or specify one or more pixel subwindows for a given sensor 12.

Although one image sensor 12 is shown one or more image sensors, imaging devices, etc. may used. Optical assembly 11 may include multiple lens, such as lens L1, L2. The control system 19 may also provide image processing functions and a user interface through an image processing system or image system 19b. The illumination system 20 is shown external to the optical assembly but may also be incorporated inline with the optical assembly. The illumination system 20 may be a telecentric light source. Alternatively, illumination system 20 can be excluded and illumination provided by the ambient environment or luminescent portions of the target. A given illumination system 20 may include one or more light sources and other optical elements associated therewith including shutters, ballasts, drive circuits, strobe controls, and other light transforming elements.

A given imaging system 10 may include one or more image sensors 12 in electrical communication with the control system, wherein the one or more image sensors support data collection relative to a first pixel subwindow, a second pixel subwindow, and an N pixel subwindow. N may be a positive integer and can be set such that a given image sensor is divided into rectangles of subwindows that cover all imaging elements of the sensor. In one embodiment, the image processing system 19b includes a pixel value processor to synthesize a 2D image from at least one frame exposure that includes image sensor pixel values. The pixel value processor can be implemented using a computer-processor in one embodiment. In another embodiment, the pixel value processor includes a computer processor in electrical communication with one or more FPGAs programmed to specify and/or read out subpixel windows of image data from a given sensor.

A target 15 passes through a focal plane 16 of an imaging system 10 along an axis of relative motion 21. The target is generally disposed in an imaging environment. The focal plane of the imaging system is tilted 18 with respect to the motion axis. The tilt angle can range from greater than 0 to less than 90 degrees in one embodiment. In one embodiment, the tilt angle ranges from about 1 degree to about 45 degrees. This tilt may be achieved with the Scheimpflug imaging principle, however there are many well-known ways to create a focal plane (or other focal surface shape) that cuts through the axis of motion. The image sensor 12 is suitably positioned to image the tilted focal plane projected by the optical assembly The target may scatter or reflect light from the light source of illumination system 20 or fluoresce in response to receive light from the illumination source or from another source or as a result of another basis for triggering fluoresce.

The imaging system has a finite depth of field 13, a range of height that is in focus (or substantially in focus) above and below the focal plane. Combined with the width of the field size (perpendicular to the plane of FIG. 1) a tilted slab of space is defined, the focal volume 17. As the target 15 passes through the focal volume 17, target features appear in focus within a relatively large range of focus 14, defined by the focal plane angle 18, the field size, and the depth of field, as shown in FIG. 1. In one embodiment, the image sensor 12 can be angled relative to the focal plane. In one embodiment, the one or more sensors receive an image of the target, the first pixel subwindow aligned with at least a portion of the image of the target.

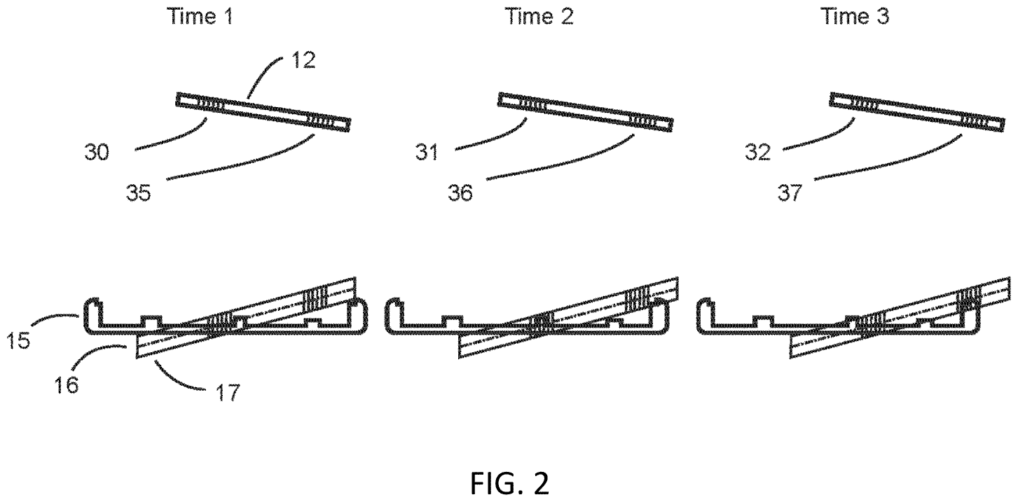

FIG. 2 shows the same side view of the target 15 and image sensor 12 of FIG. 1.

Pixel subwindows 30, 31, 32, 35, 36, and 37 are represented on the image sensor 12 at each of three moments in time (Time 1, Time 2, and Time 3). Each of the pixel subwindows is 5 rows of pixels across as drawn. These subwindows each map to a volume of space within the focal volume. From this edge view, the subwindows represent 5 rows of narrow prismatic volumes. Each of these volumes is an extent in space that a target feature can pass through and form an in-focus image within the pixel subwindow.

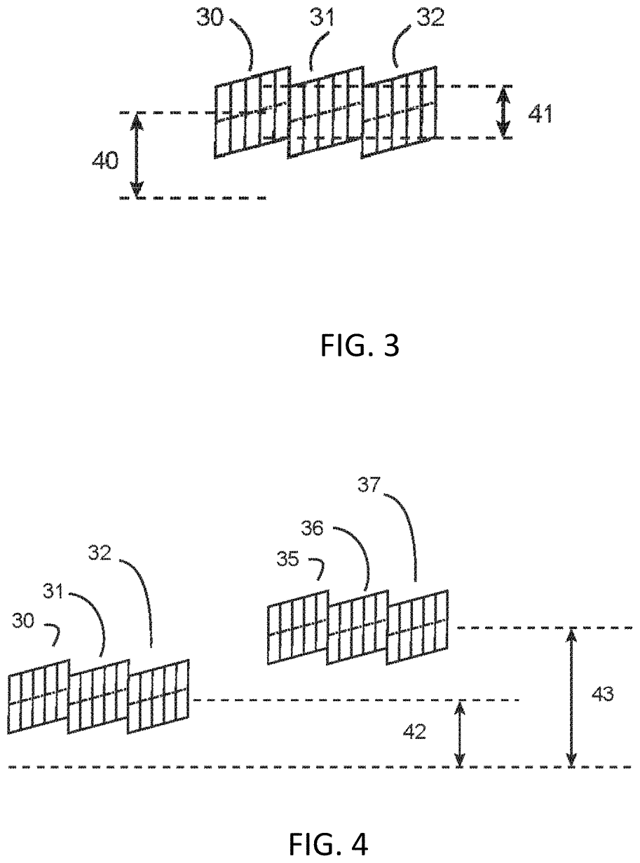

As the target passes through a pixel subwindow, windowed frames of image data are collected by the image sensor. These image data are juxtaposed in the memory of control system 20, which may include a computer to reconstruct the scene captured by an effective sensing volume shown, edge on, in FIG. 3. In this case, subwindows 30, 31, and 32 are combined. Thus, a contiguous 2D image with an effective focus height 40 and an effective depth of field 41 is synthesized. In one embodiment, the one or more sensors receive a set of rays from the target, the first pixel subwindow aligned with at least a portion or subset of the ray from the target.

FIG. 4 illustrates the stitching of pixel subwindows from two sensor locations to form two 2D images with different focal height according to an embodiment of the disclosure. In this case, subwindows 30, 31, and 32 are combined. In turn, In this case, subwindows 35, 36, and 37 are combined.

### Multiplexing

Capturing multiple, aligned 2D images of a target feature under potentially different exposure conditions, within just one pass of the stage is a further advantage of various embodiments of the disclosure.

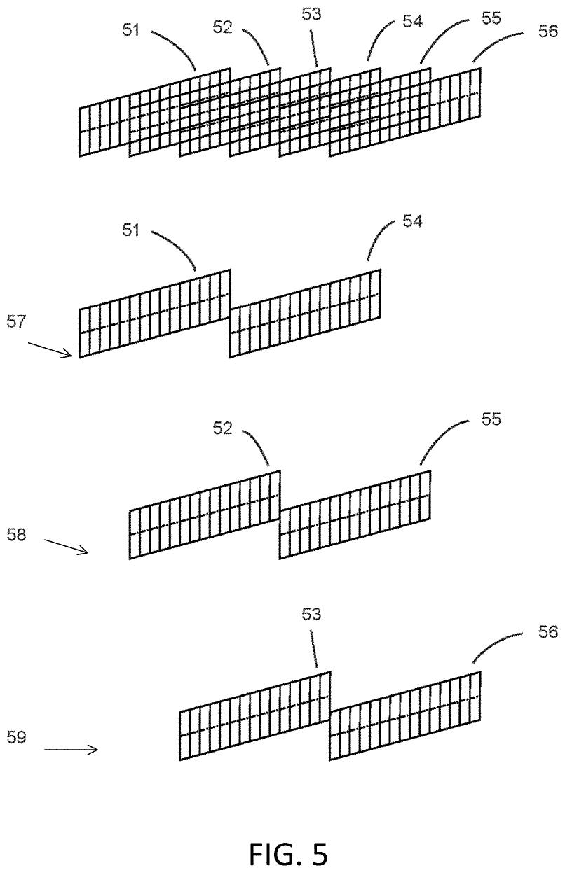

FIG. 5 shows multiplexing with a single focus height, though the same method applies with multiple focus heights. A pixel subwindow of 15 pixels is shown at six time instances 51, 52, 53, 54, 55, and 56. Rather than capturing a frame every time the target passes through 15 pixel rows of space, which would capture a single 2D view of the target similar to the view collected in FIG. 3, frames (including the pixel subwindow of interest) are captured every time the target traverses just 5 pixel rows of space. Thus, each point on the target is captured three times. In this case, three sets of image pairs 57, 58, 59 are collected. Each set can be exposed with a different conditions such as different light conditions including the duration, direction, and spectral content of the light. For example, two adjacent regions of a part with different components can generated different images when subjected to different illuminations, such as different flashes, or other imaging modes. The multiplexing methods allow for image subsets to be used with better relative images based on differing lighting or other imaging parameters. All of the image pairs can be combined in one embodiment.

Multiplexing or combining images allows for targets that have regions or features of interest with dissimilar optical properties, such as shiny, bright, dim, specular, reflective, etc. that would be imaged differently in different images to be compensated for in a combined image. Such a combined image is formed from multiple images to effectively assemble an image with improved images of the different components taking under different conditions to improve the relative imaging of the various components. Regions of differing heights and other structural features can be imaged individually with better results using pixel subwindows that align/are alignable with such components.

### Degree of Multiplexing

Since three views are captured in the example of FIG. 5, this is called three-fold multiplexing. Extending this idea, if a frame is captured at each time the target advances three pixels, this is five-fold multiplexing.

While it is often advantageous to have a regular rhythm in time for collecting image frames, this is not a necessary condition for multiplexing, even with perfect pixel-wise alignment between the synthesized 2D images. Supposing a pixel subwindow width of 15 pixel rows is used but four-fold pixel multiplexing is desired. An equal spacing in time would suggest capturing frames when the target advances 3.75 pixels. However, if these images are to be aligned, image data must be interpolated to estimate the pixel values on a single grid. Interpolation in this case is not ideal. Instead frames are captured that align with integer pixel offsets of the target image on the image sensor. For example, images are captured with target image offsets of 0, 4, 8, and 12 pixels. The rhythm has a different spacing in time after the fourth frame of each group in the sequence (3 pixels of motion, with the other frames spaced by 4 pixels of motion), but the pixels can be aligned without interpolation.

### Multiplexing Exposure and Lighting Conditions

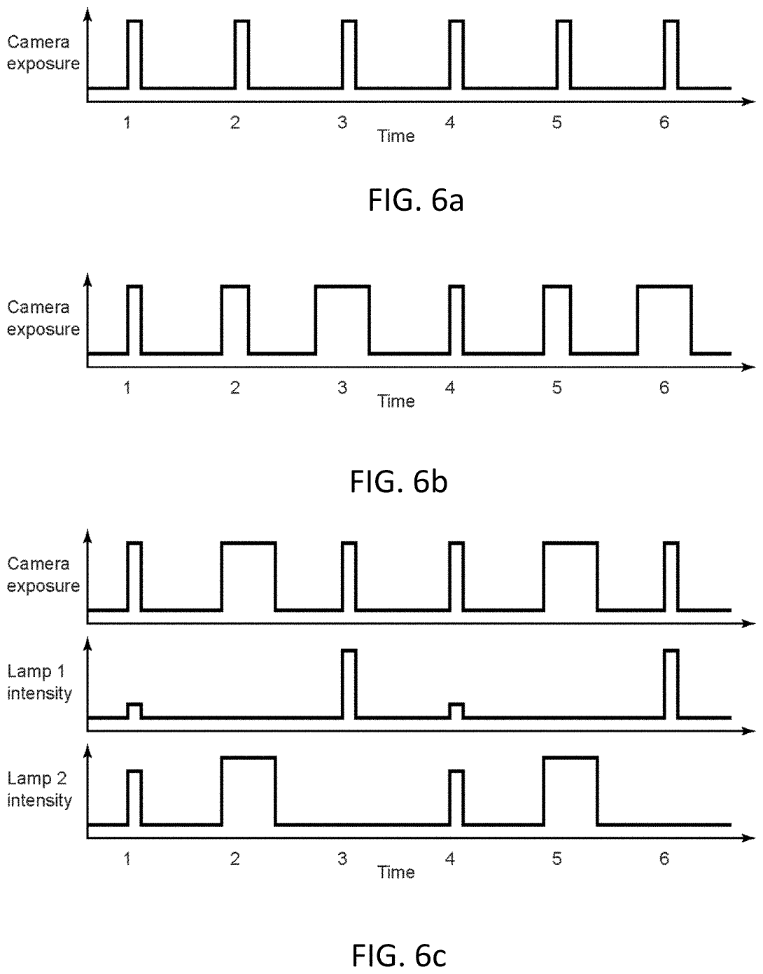

FIG. 6a shows a regular sequence of frame exposures, where each of the six frames is exposed for the same duration. This exposure pattern is appropriate for n-fold multiplexing, with n>1. Even in the case of e.g. three-fold multiplexing, and even with no other differences between frames, multiple independent images of the target can be useful in sensing target properties, such as target feature dimensions. Each measurement has an intrinsic uncertainty, and by combining multiple measurements, it is sometimes possible to reduce this uncertainty.

FIG. 6b shows an exposure sequence for the 6 frames with differing exposure times. This sequence would be appropriate for producing three sets of image pairs with different exposure times such as pairs 57, 58, and 59 of FIG. 5. The 2D image synthesized from frames captured at times 1 and 4 has a short exposure time (e.g. 5 microseconds); the 2D image synthesized from frames captured at times 2 and 5 has a medium exposure time (e.g. about 10 microseconds); and the 2D image synthesized from frames captured at times 3 and 6 has a long (e.g. about 50 microseconds) exposure time. Such a set of three 2D images can capture a higher dynamic range of the target features than the image sensor can capture in a single frame.

For example, considering a target with bright and dark features, the dark features must be exposed for a longer exposure time (e.g. about 50 microseconds), and the bright features for a shorter exposure time (e.g. about 5 microseconds). Notably, these three frames will have pixel-wise alignment. The duration of short, medium, and long exposures will depend on the intensity of the illumination and the speed of the moving target. Ideally, the long exposure time is still sufficiently short to reduce image blur to a level that does not reduce the accuracy of subsequent image analysis.

FIG. 6c shows an exposure sequence for the 6 frames of FIG. 5 using an illumination system with two light sources, such as lamps. In general, the use of lights sources, such as lamps, and others may include any suitable devices capable of generating electromagnetic radiation suitable for illuminating or imaging. As a result, infrared, ultraviolet, and other imaging spectrum in addition to visible light are within the scope of the disclosure. The 2D image synthesized from frames 1 and 4 has a short exposure time and a blend of light from both lamps; the 2D image synthesized from frames 2 and 5 has a long exposure time, illuminated only with Lamp 2; and the 2D image synthesized from frames 3 and 6 has a short exposure time and illumination only from lamp 1. With respect to the various imaging and illumination systems and combinations thereof disclosed herein a given light source can be selected based on a wide range of options and parameters. Suitable light sources may be selected for a given embodiment disclosed herein based on one or more of the foregoing:
angular content, as in a spot light, back light, ring light, dome light, epi illumination, dark-field illumination, etc.;
diffuser properties;
power;
spectral content, as in color, coherence, IR, UV, or other excitation spectrum (e.g. as for fluorescence, e.g. in combination with a multi-band filter set);
polarization;
optical phase, as in an interferometric setup;
spatial content, as in a pattern, slit, point, line, or aperture projection;
modulation parameters, in the case of a lamp used with an optical modulator;
combinations of the foregoing; and
other optical, physical, electrical, and chemical properties of a given light source.

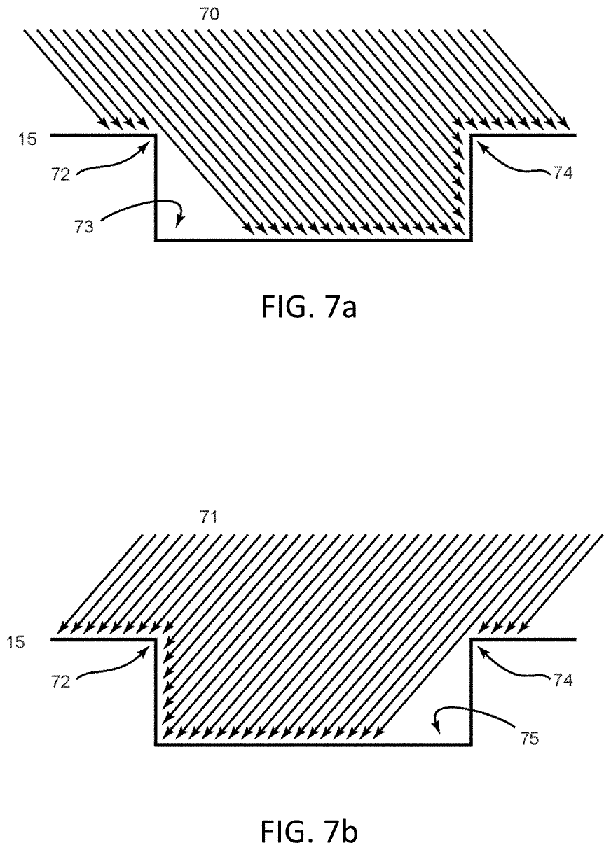

FIGS. 7a and 7b illustrate an example of lamps with differing angular light content falling over a target 15 with a pocket that includes two edge features 72 and 74. Target 15 is shown a cross-sectional view of a trough or channel with a pocket bounded by vertical edges. Often machine vision techniques will attempt to locate these features using image intensity contrast. In FIGS. 7a and 7b, the contrast will arise from shadows, 73 and 75, cast over the edge features. In FIG. 7a, light 70 from a first lamp casts a high-contrast shadow over feature 72 on the target, but washes out any contrast for feature 74. Similarly, in FIG. 7b, light 71 from a second lamp provides a high contrast signal for feature 74, at the cost of removing much of the contrast signal for feature 72 in the image. In this case, an ideal signal from each feature can be collected with two-fold multiplexing in accordance with the disclosure.

Another aspect of the disclosures relates to the alignment capability for 2D machine vision on 2D images provides a measurement of part-to-part XY position changes. These measurements can update the locations of height measurement points. Thus, since the height measurement points are perfectly aligned with the high-resolution 2D ROI images, the height measurement points can be aimed at even the finest features of each part with great precision and confidence. This capability could alleviate the need for perfect part locating systems, or for additional part position sensors, and thus save significant cost, time in adapting fixtures for holding parts, and cycle time on part handling.

Synchronizing Illumination with Camera Exposure

In general, as part of the implementation of systems and methods to image targets such as objects or regions thereof it is advantageous to synchronize lamp illumination such as flash with the period of image capture. Various illumination sources, such as lamps, LEDs, strobes, and combinations thereof can be used in a given system. Various drive and control circuits for a given source of illumination and for a given imaging sensor or camera can be controlled by one or more integrated systems.

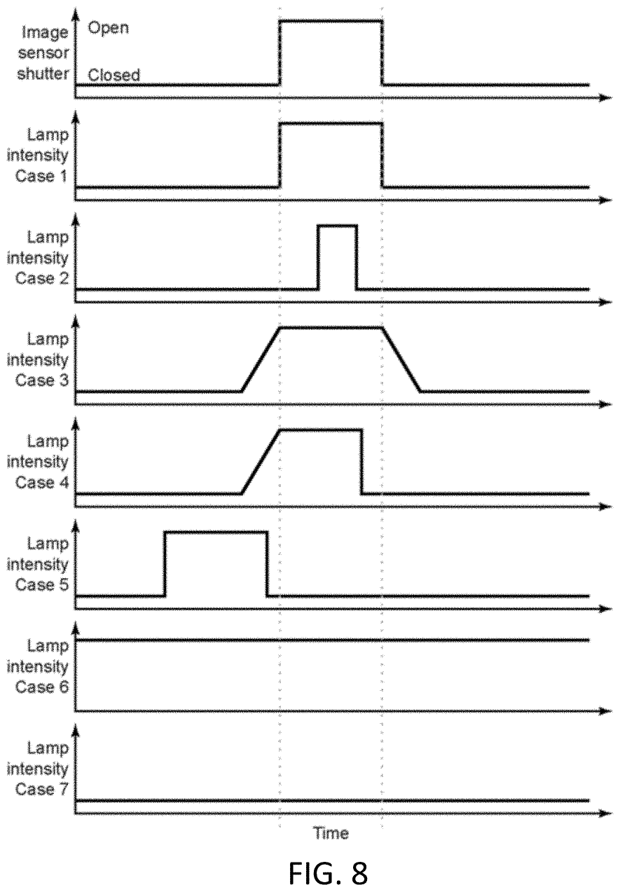

FIG. 8 includes various examples or cases of the relative time periods during which a light source such as a lamp has a particular intensity level for a particular period of time that changes over a given image data captures sessions. The various intensity versus time curves shown in FIG. 8 can be adjusted to effectively include one or more pulse or standing waves corresponding to intensity changes on each plot. The use of various lamp intensity pulses or active states over time can be combined with image capture event to produce various images for a given object or set of objects that can be used to enhance the resolution or detection of various targets.

In Case 1, the lamp was actuated, such as by strobing, to be coincident in time with image sensor data capture. Line cameras and other cameras can be used with a shutter to control imaging time or otherwise actuated during imaging to synchronize image capture or shift it in time relative to an illumination event.

Case 2 shows a light pulse, such as a strobe pulse, that is a fraction of the camera exposure's duration. If the target's illumination mainly comes from the lamp, the lamp pulse duration will be the effective exposure time. Image sensors generally have a minimum exposure time, but it could be desirable to use a faster effective exposure. For example, a quick effective exposure helps to reduce motion blur in an image of a moving target. Accordingly, in various embodiments light pulses from an illumination source are triggered that is subset or fraction of the timer period a given imaging sensor or array of such sensors are exposed or actuated for image capture.

Case 3 shows the rise and fall (ramps) time of a lamp's intensity. These ramps are an artifact of certain lamps and lamp driving circuitry. In some embodiments, multiple illumination sources of the same or variable intensity can be actuated according to one or more patterns to increase or mitigate or otherwise modify the exemplary cases depicted in FIG. 8.

Case 4 shows the rapid fall time of a specialized lamp driving circuit, used to create a short effective exposure time in combination with the image sensor's shutter.

Case 5 shows a lamp energizing a luminescent target such that the target will emit light after the lamp has been turned off. In this case, the captured image will be of the target's residual luminescence. This residual luminescence can change and decrease over time in a time series of images base on the optical and luminescent properties of the target.

Case 6 uses a lamp that is on for an extended duration before and after initiating image capture with a given imaging sensor such as one or more line cameras or other cameras. The exposure time is determined by the image sensor shutter time or other control or drive circuit parameters. All of the lamps and imaging sensors or cameras can be controlled by one or more processors, circuits, ASICs, or other systems to facilitate synchronizing or changing image capture duration and activation relative to lamp activation, duration, and intensity. The color and other optical properties of some illumination sources can also be controlled and varied to produce different images for a given target which can be compared, modified, combined or otherwise used to improve or segment a given target or portion thereof.

In Case 7, the image of the target is exposed without illumination from the lamp. For example, the target is imaged using ambient illumination or using light from a self-luminous target, such as an OLED display.

Synchronizing Frame Capture with a Stage

As depicted in FIG. 1, a preferred embodiment of the disclosure includes a sensor head, including elements 12 and 11, viewing a target 15 with a stage 21 imparting a relative motion between the two. The stage can move the target, the sensor head, an optical element (e.g. in a system with a rotating, flapping, or scanning mirror), or a combination of these to impart a motion of the target image across the image sensor, effectively sweeping the target through the volume of focus. The stage is equipped with a position read-out such as an optical encoder. The encoder output is provided to a subsystem that controls the camera shutter and lamp strobes. This timing subsystem is responsive to the target's motion, the desired focal height(s) for imaging, the desired timing of the lamp(s) with respect to the shutter, the degree of multiplexing, user-defined regions of interest, and so on.

Some implementations of imaging systems and methods disclosed herein may use a reactive timing subsystem, such as, for example, one that reacts to the stage position or other positional references or landmarks to trigger one or more imaging sensors, shutters, and/or light source. Alternatively, in other embodiments a predictive timing system may be used, which has various advantages. Such a predictive system may include a forward model of the mechanics, communication or coordination with the stage/imaging region or support, control systems, control electronics, user interface controls, a phase locked loop, or similar architecture. Among other benefits, a predictive timing subsystem can handle more of the cases in FIG. 8, for example, than a purely reactive timing subsystem. Although, in certain embodiments, a reactive timing subsystem may be suitable and the systems can be combined or switched between in response to user selections or for different regions of the stage/imaging field.

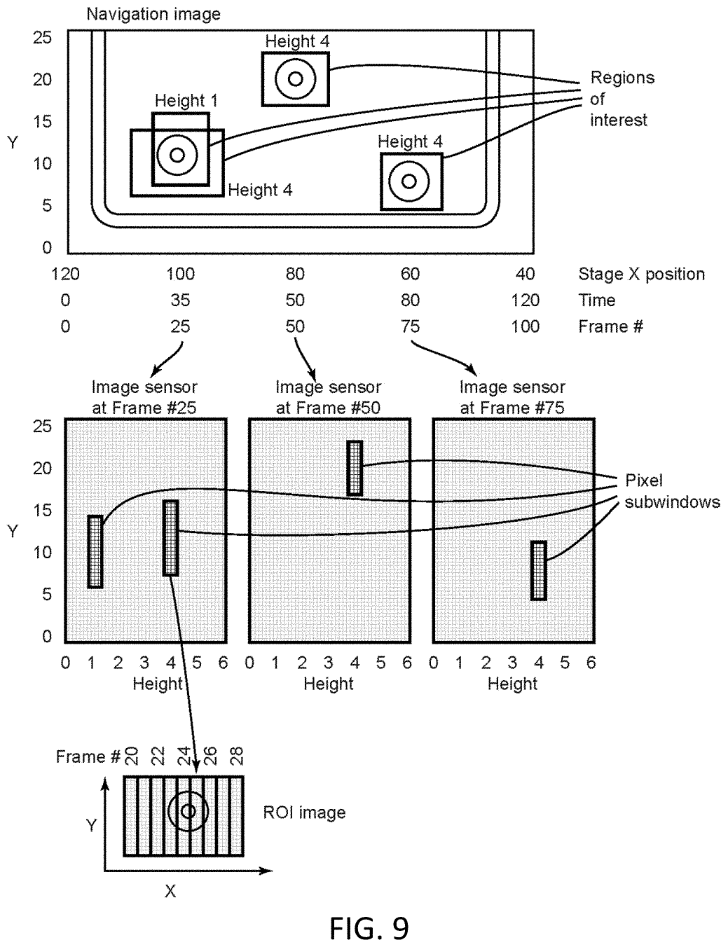

FIG. 9 illustrates the behavior of the timing subsystem in a target scene. In this case, target parts are traveling on a translation stage past the sensor head in an automated industrial quality control system. A user selects features, regions of interest, to image on a first part, and thereafter, many more nominally identical parts pass through the system. These selections may be through one or more user interface panels such as command line or graphical user interfaces.

On the top of FIG. 9 a user selectable navigation image is depicted that includes a map of the target scene to aid a user in selecting regions of interest and focus heights for those regions. The navigation image is collected on the first target part during an initial setup of the instrument. Potentially, to minimize the collection, transmission, and processing of image data, subsequent target parts are imaged just in the regions of interest at their respective focus heights.

The top scale below the navigation image is the X position of the stage supporting the target. As indicated by the stage axis 21 in FIG. 1, the part moves to the left (X decreasing) over time. The next scale below is the time in arbitrary units. The stage accelerates to a peak speed in the first 50 units of time and then decelerates. The bottom scale indicates the frame count below the time index. Frames are timed in synchrony with the stage position so that frames are captured when the image of the target advances the width of the pixel subwindows at the image sensor.

Three sample image sensor frames are shown below the navigation image. In those frames, pixel subwindows are selected on the image sensor for read-out. The pixel subwindow selection is programmatically determined from the parameters of the regions of interest, and it can vary from time to time as the target moves relative to it or as other variable change in a given imaging environment.

Image data from the pixel subwindow readout of the frames are assembled into 2D ROI images, as shown on the bottom of the figure. For clarity of the drawing, the details of multiplexing and lamp triggering are not shown. Notice that Frame 25 (highlighted by an arrow from the above illustrated image sensor) includes portions from two overlapping regions of interest with different focus heights. The pixel subwindows for Frame 24 (not shown) are the same as for Frame 25, and the image data from the right hand pixel subwindow from those two subsequent frames (no multiplexing) are juxtaposed in the ROI image, as shown.

Synchronizing Frame Capture with a Flow

The target may be in flow. For example, the target is a part on a traveling conveyor belt or sliding down a slide. For another example, the target is a body in a fluid flow, such as a cell in a channel, or a blueberry in an air stream. In any case, a measure of the target's motion equivalent to a stage encoder is provided to the timing subsystem of the disclosure. The measure can be an average measure of the flow speed, or in the case of a pulsatile flow, a predictive signal, for example.

### Confocal Pattern Projection

A preferred embodiment of the disclosure include one or more lamps/light sources. When the lighting conditions of a lamp includes spatial content, the lamp is combined with some form of projection optics.

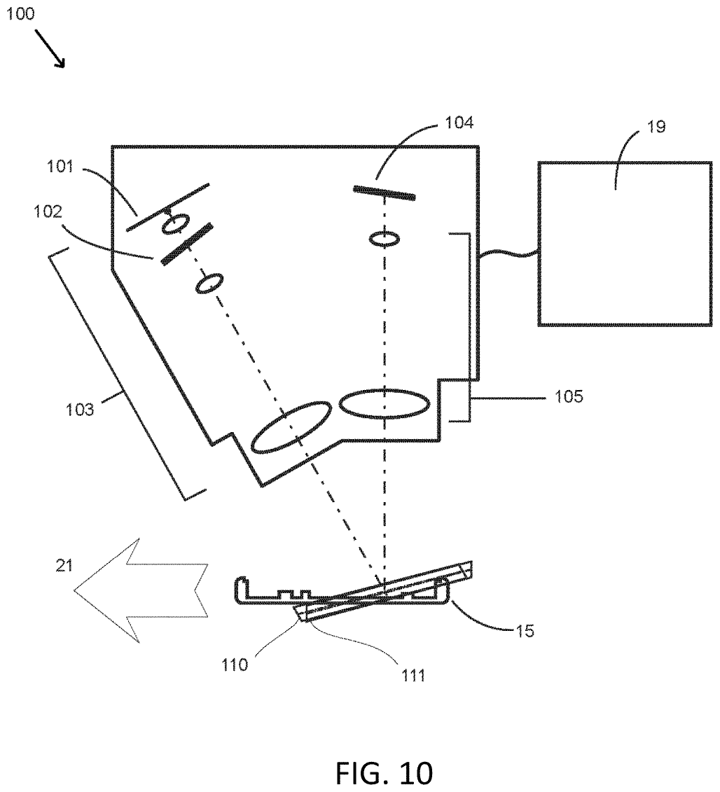

FIG. 10 shows a multi-range imaging system 100, including a projection system providing spatial content illumination to the target scene. A lamp 101 illuminates a spatial filter 102, such as a photomask, an LCD pixel array, a digital micromirror device (DID) or an array thereof, a spinning disk of structures like microlenses or occlusions, a line generator, a spatial modulator and combinations thereof. A projection lens system 103 brings the spatial content to focus in a projection focal volume (focal plane 110 and focal range 111) substantially coincident with the imaging focal volume. Substantially coincident generally refers to overlapping to some degree, whether or whole in or part, with a given distance or volume, such as a focal distance or focal volume.

The confocal pattern projector has many applications. Among them are the uses of confocal microscopes—greater isolation of features in a focal plane. The geometry in FIG. 10, however, includes a triangulation angle between the projection path and the imaging path. Such a setup is preferred for triangulation range-finding with a projected pattern.

Pattern projection range-finding using triangulation is well known, and there are many patterns and pattern sequences for stationary and moving targets. These include laser line triangulation. In laser line triangulation, a single stripe of illumination is projected onto the target and viewed from a triangulation angle. The apparent distortion of the line in the sensed image contains height information for the illuminated portion of the frame. Unfortunately, however, most of the frame is not illuminated, and thus only a tiny portion of the frame contains useful height information.

In this way, the efficiency of laser line triangulation is unsuitable for various applications. Various pattern projectors can be used to improve this efficiency. For example, a projection subsystem can be used to project a pattern or a sequence of a few patterns to expose a greater portion of the target scene and to provide height information in a greater portion of the frame. For example, in Accordion Fringe Interferometry, a sequence of three or more patterns is projected to a stationary target to provide height information at every camera pixel.

In the context of the disclosure, multiple projected patterns can be timed with the image frames within a multiplexed imaging sequence to enable such pattern projection sequences. Pattern sequences previously only suitable for stationary targets within a limited range of focus heights can thus be used in the context of the disclosure with moving targets and in a much larger range of focus heights.

In a preferred embodiment of the disclosure, a projector may include a fixed photomask is used. The pattern is fixed within the imaging focal volume, and as the part translates through the volume, a point on the target is illuminated by a changing portion of the pattern. Thus, the pattern modulator—a complex, expensive, and large component of legacy systems—is replaced by a simple, inexpensive, and small photomask, and the action of pattern modulation arises from the part's own motion.

There are many choices for a useful pattern for the photomask. In a preferred embodiment, the pattern is a 1D or 2D bar code. The code is sampled in each frame of an n-fold multiplexing sequence, resulting in a time series for the brightness of a point on the target recorded as a pixel value for each of the set of n synthesized 2D images. With a suitably chosen bar code, the time series uniquely identifies a portion of the bar code, which thus encodes height information about the target viewed from the triangulation angle. For the sake of an example, the bar code can contain a pseudo-random digital sequence found to have the unique identification property described above for a given n.

### Application to Industrial Inspection

Inspections for mobile phone components are subject to frequent customer revisions. Using prior art sensors, each revision initiates a flurry of engineering work to provision and mechanically support specific sensors for the new list of inspections. This process takes time and can bring friction into a customer's experience.

The mobile phone customer desires a vendor that can adapt to design revisions immediately, and in a comfortable process. That's where the disclosure fits in. Our intention is to measure any location within the entire part's maximum envelope. Thus, generally, the disclosure requires no specific provisioning or mechanical modifications or custom brackets as inspection lists are established and updated. Moreover, the same metrology system can switch between part types at any time, with software control.

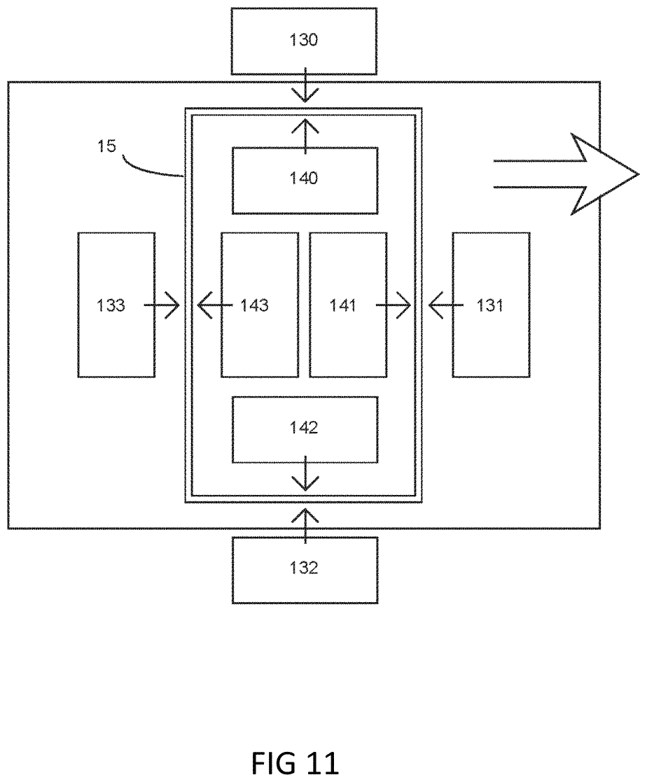

In one application example, multi-range imaging sensors can be combined with mirrors to view a large number of surface features of mobile phone parts. FIG. 11 illustrates an arrangement of right angle mirrors (objects 130, 131, 132, 133, 140, 141, 142, and 143) to view four external side wall locations and four internal side wall locations of a target 15 using overhead mounted multi-range sensors. The arrows emanating from the mirrors represent the direction of viewing. In particular, mirrors 130 and 132 are fixed relative to the moving target 15 while all other mirrors travel with the target. As a result, as the target passes mirrors 130 and 132, the external side walls are scanned by the sensor including multiple focal planes.

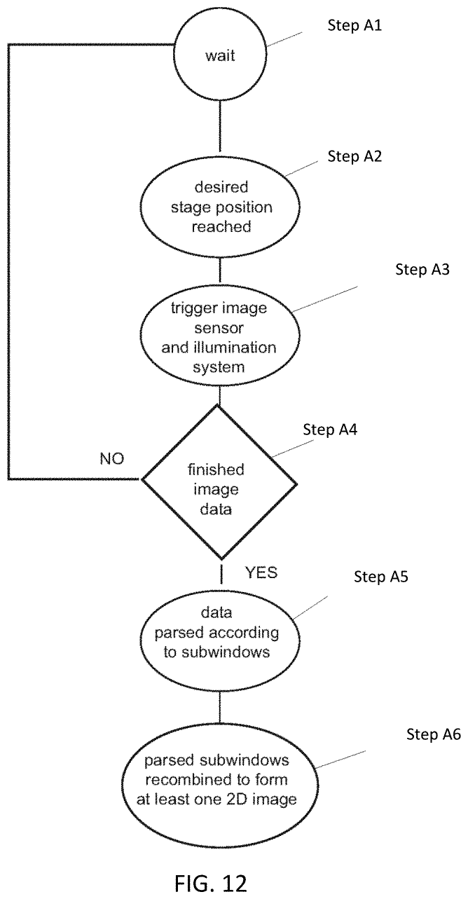

FIG. 12 illustrates a preferred method for using a multi-range imaging system to image a target. In this case, the system may include the components shown in FIG. 1, such as, a target mounted on a translating stage with a stage encoder, an optical assembly including an image sensor, an illumination system, and a computer system. In this case, the computer system includes a host machine and a programmed FPGA used for high performance control of the image sensor, illumination, and data collection. The benefits of the FPGA include expedited subwindow data extraction and defining pixel subwindows in some embodiments. For example, in one embodiment, one or more FPGA can be configured to specify a given pixel subwindow and/or read data out associated with such as subwindow at a rate of less than about R for various embodiments. In one embodiment, R is less than about 2 seconds. In one embodiment, R is less than or equal to about 1 second. In one embodiment, R is less than or equal to about 0.5 seconds. In one embodiment, R ranges from about 0.1 seconds to about 2 seconds.

The mounted target is moved relative to the optical assembly. The computer waits for the target to reach a predetermined location as indicated by monitoring the stage encoder. Step A1. At the predetermined location (Step A2), the image sensor and illumination are triggered (Step A3). Thus, a frame of image data, including at least one subwindow of pixels is collected (Step A4). If more image data is to be obtained or needed, the loop repeats until all the image data has been obtained. Once it has been obtained, the method moves on to data parsing. Synchrony of the stage, illumination, and image sensor exposure are orchestrated by the computer/control system. Additional frames of data are collected at subsequent predetermined locations. When all of the frames are collected, the computer system parses the frames (Step A5) and combines the subwindows into at least one 2D image (Step A6) such as for example, that depicted in FIG. 3.

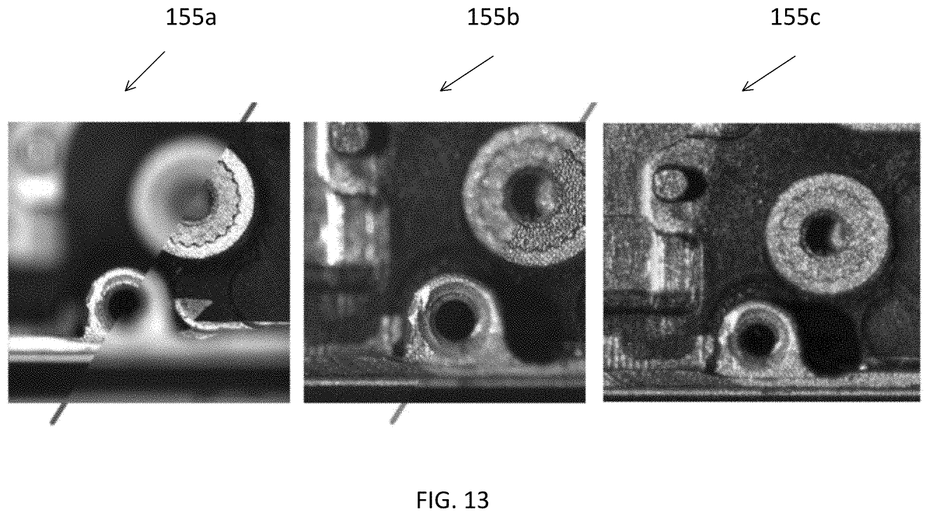

FIG. 13 is a series of images of an imaged target that includes various components that have been obtained according to different imaging methodologies including those of the disclosure. Image 155a shows a convention imaging system focus at each level with a different camera. Image 155b shows an image obtained according to an embodiment of the present disclosure with a multi-plane focus. In turn, image 155c shows an image obtained according to an embodiment of the present disclosure that is a generated planarized image.

For image 155a, a conventional camera system was brought to focus at each of two planes and collected images without moving the target to emulate a system with multiple conventional cameras. With image 155b, a portion of images of a target are captured using a single instrument, in a single stage pass according to the disclosure. Finally, for image 155c, as shown, for small parts arrayed at random on a moving belt, the best plane of focus at each region of interest might not be known in advance. In those cases, it is useful to collect imagery that contains high resolution through a depth of field beyond the diffraction limit. Image 155c is synthesized by merging the focus stack collected by an embodiment of the disclosure in a single stage pass. In one embodiment, this is referred to as planarized imaging and the output is a planarized image.

The disclosure has been described in terms of particular embodiments. It will be understood that various modifications may be made without departing from the spirit and scope of the disclosure. For example, optical components suitable for imaging translating objects are wide ranging in form and function. The relative position and orientation of targets can be changed while a given system embodiment is able to image the targets using different imaging sensors and associated lighting scenarios that can be varied according to the various parameters disclosed herein. Custom optics that reduce the number of individual components or replace individual components can be designed and implemented.

Different illumination sources can be used without limitation and combined as arrays or based on various coordinate systems relative to moving objects being studies. These sources can include changes in the wavelength of radiation or the spectrum of radiation for non-monochromatic light. Stroboscopic illumination can be achieved by a number of means, including mechanical and electronic shutters. Various light sources can be used, without limitation, such as light source having one or more components. Further, light sources can be selected or otherwise paired with fluorescent compounds or labels. A given fluorescent label or compound can be used to tag or mark a biological target such as a gel containing biological samples that are identified using electrophoresis or other techniques by which the samples move and are imaged.

A mechanical stage, imaging field or platform, and target could be part of or controlled by an automated handling system. Targets can include any viewable moving object. Objects can include man-made or natural structures. Optical systems capable of accommodating larger structures and small structures can be built. These systems may allow imaging of large moving objects such as people or vehicles. In addition, the target is not limited to fast moving objects. Slow moving structures may be measured as well as periodic and a periodic motions. For example, a time lapse sequence of images or a sequence of measurements separated by a duration much longer than the period of motion. In various embodiments, different speeds or rates of motion can be imaged. For example, for targets of a macroscale (about 2 cm to about 15 cm along a dimension) the target may be imaged if moving at a speed of from about 1 mm/sec to about 10000 mm/sec. Further, the speeds of targets are suitably scaled when target dimensions become either microscopic or much larger than 15 cm.

The processes associated with the present embodiments may be executed by programmable equipment, such as computers. Software or other sets of instructions that may be employed to cause programmable equipment to execute the processes may be stored in any storage device, such as, for example, a computer system (non-volatile) memory, an optical disk, magnetic tape, or magnetic disk. Furthermore, some of the processes may be programmed when the computer system is manufactured or via a computer-readable memory medium.

It can also be appreciated that certain process aspects described herein may be performed using instructions stored on a computer-readable memory medium or media that direct a computer or computer system to perform process steps. A computer-readable medium may include, for example, memory devices such as diskettes, compact discs of both read-only and read/write varieties, optical disk drives, and hard disk drives. A computer-readable medium may also include memory storage that may be physical, virtual, permanent, temporary, semi-permanent and/or semi-temporary.

Computer systems and computer-based devices disclosed herein may include memory for storing certain software applications used in obtaining, processing, and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable memory media.

In various embodiments of the present disclosure, a single component may be replaced by multiple components, and multiple components may be replaced by a single component, to perform a given function or functions. Except where such substitution would not be operative to practice embodiments of the present disclosure, such substitution is within the scope of the present disclosure.

In general, it may be apparent to one of ordinary skill in the art that various embodiments described herein, or components or parts thereof, may be implemented in many different embodiments of software, firmware, and/or hardware, or modules thereof. The software code or specialized control hardware used to implement some of the present embodiments is not limiting of the present disclosure. For example, the embodiments described hereinabove may be implemented in computer software using any suitable computer programming language such as .NET, SQL, MySQL, or HTML using, for example, conventional or object-oriented techniques. Programming languages for computer software and other computer-implemented instructions may be translated into machine language by a compiler or an assembler before execution and/or may be translated directly at run time by an interpreter.

Examples of assembly languages include ARM, MIPS, and x86; examples of high level languages include Ada, BASIC, C, C++, C#, COBOL, Fortran, Java, Lisp, Pascal, Object Pascal; and examples of scripting languages include Bourne script, JavaScript, Python, Ruby, PHP, and Perl. Such software may be stored on any type of suitable computer-readable medium or media such as, for example, a magnetic or optical storage medium. Thus, the operation and behavior of the embodiments are described without specific reference to the actual software code or specialized hardware components.

In various embodiments, the computer systems, data storage media, or modules described herein may be configured and/or programmed to include one or more of the above-described electronic, computer-based elements and components, or computer architecture. In addition, these elements and components may be particularly configured to execute the various rules, algorithms, programs, processes, and method steps described herein.

Implementations of the present disclosure and all of the functional operations provided herein can be realized in digital electronic circuitry, or in computer software, firmware, or hardware, including the structures disclosed in this specification and their structural equivalents, or in combinations of one or more of them. Implementations of the disclosure can be realized as one or more computer program products, i.e., one or more modules of computer program instructions encoded on a computer readable medium for execution by, or to control the operation of, a data processing apparatus.

The computer readable medium can be a machine-readable storage device, a machine readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). In various embodiments, reading of a given set of pixel subwindow data is implemented with one or more FPGAs or other ASICs to reduce system latency and to compensate for target movement speed.

A computer or computing device can include machine readable medium or other memory that includes one or more software modules for displaying a graphical user interface such as interface. A computer or computing device can also be headless. A computing device can exchange data such as monitoring data or other data using a network, which can include one or more wired, optical, wireless or other data exchange connections. A computing device or computer may include a server computer, a client user computer, a personal computer (PC), a laptop computer, a tablet PC, a desktop computer, a control system, a microprocessor or any computing device capable of executing a set of instructions (sequential or otherwise) that specify actions to be taken by that computing device. In one embodiment, the user may select a region of a target, such as one or more regions or features of interest. That user selection relative to the target is used to identify the pixel subwindows of interest on one or more sensor arrays as applicable.

Further, while a single computing device is illustrated, the term “computing device” shall also be taken to include any collection of computing devices that individually or jointly execute a set (or multiple sets) of instructions to perform any one or more of the software features or methods or operates as one of the system components described herein.

Moreover, a computing device can be embedded in another device, e.g., a mobile telephone, a personal digital assistant (PDA), a mobile audio player, a Global Positioning System (GPS) receiver, to name just a few. Computer readable media suitable for storing computer program instructions or computer program products and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; CD ROM and DVD-ROM disks or other types of tangible medium suitable for storing electronic instructions. These may also be referred to as computer readable storage media. The processor and the memory can be supplemented by, or incorporated in, special purpose logic circuitry.

A machine-readable signal medium may include a propagated data signal with computer readable program code embodied therein, for example, an electrical, optical, acoustical, or other form of propagated signal (e.g., carrier waves, infrared signals, digital signals, etc.). Program code embodied on a machine-readable signal medium may be transmitted using any suitable medium, including, but not limited to, wireline, customer networks, vendor or service provider networks, wireless, optical fiber cable, RF, or other communications medium.

While this disclosure contains many specifics, these should not be construed as limitations on the scope of the disclosure or of what may be claimed, but rather as descriptions of features specific to particular implementations of the disclosure. Certain features that are described in this disclosure in the context of separate implementations can also be provided in combination in a single implementation. Conversely, various features that are described in the context of a single implementation can also be provided in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Throughout the application, where compositions are described as having, including, or comprising specific components, or where processes are described as having, including or comprising specific process steps, it is contemplated that compositions of the present teachings also consist essentially of, or consist of, the recited components, and that the processes of the present teachings also consist essentially of, or consist of, the recited process steps.

In the application, where an element or component is said to be included in and/or selected from a list of recited elements or components, it should be understood that the element or component can be any one of the recited elements or components and can be selected from a group consisting of two or more of the recited elements or components. Further, it should be understood that elements and/or features of a composition, an apparatus, or a method described herein can be combined in a variety of ways without departing from the spirit and scope of the present teachings, whether explicit or implicit herein.

The use of the terms “include,” “includes,” “including,” “have,” “has,” or “having” should be generally understood as open-ended and non-limiting unless specifically stated otherwise.

The use of the singular herein includes the plural (and vice versa) unless specifically stated otherwise. Moreover, the singular forms “a,” “an,” and “the” include plural forms unless the context clearly dictates otherwise. In addition, where the use of the term “about” or “approximately” “substantially” is before a quantitative value, the present teachings also include the specific quantitative value itself, unless specifically stated otherwise. As used herein, the term “about” refers to a ±10% variation from the nominal value. As used herein, the term “approximately” refers to a ±10% variation from the nominal value. As used herein, the term “substantially” refers to a ±10% variation from a nominal value or measured state, unless otherwise defined herein.

It should be understood that the order of steps or order for performing certain actions is immaterial so long as the present teachings remain operable. Moreover, two or more steps or actions may be conducted simultaneously.

Where a range or list of values is provided, each intervening value between the upper and lower limits of that range or list of values is individually contemplated and is encompassed within the disclosure as if each value were specifically enumerated herein. In addition, smaller ranges between and including the upper and lower limits of a given range are contemplated and encompassed within the disclosure. The listing of exemplary values or ranges is not a disclaimer of other values or ranges between and including the upper and lower limits of a given range.

Whether or not modified by the term “about” or “substantially” identical, quantitative values recited in the claims include equivalents to the recited values, e.g., variations in the numerical quantity of such values that can occur, but would be recognized to be equivalents by a person skilled in the art.

The use of headings and sections in the application is not meant to limit the disclosure; each section can apply to any aspect, embodiment, or feature of the disclosure. Only those claims which use the words “means for” are intended to be interpreted under 35 USC 112, sixth paragraph. Absent a recital of “means for” in the claims, such claims should not be construed under 35 USC 112. Limitations from the specification are not intended to be read into any claims, unless such limitations are expressly included in the claims.

When values or ranges of values are given, each value and the end points of a given range and the values there between may be increased or decreased by 20%, while still staying within the teachings of the disclosure, unless some different range is specifically mentioned.

In the application, where an element or component is said to be included in and/or selected from a list of recited elements or components, it should be understood that the element or component can be any one of the recited elements or components and can be selected from a group consisting of two or more of the recited elements or components. Further, it should be understood that elements and/or features of a composition, an apparatus, or a method described herein can be combined in a variety of ways without departing from the spirit and scope of the present teachings, whether explicit or implicit herein.

It is to be understood that the figures and descriptions of the disclosure have been simplified to illustrate elements that are relevant for a clear understanding of the disclosure, while eliminating, for purposes of clarity, other elements. Those of ordinary skill in the art will recognize, however, that these and other elements may be desirable. However, because such elements are well known in the art, and because they do not facilitate a better understanding of the disclosure, a discussion of such elements is not provided herein. It should be appreciated that the figures are presented for illustrative purposes and not as construction drawings. Omitted details and modifications or alternative embodiments are within the purview of persons of ordinary skill in the art.

The examples presented herein are intended to illustrate potential and specific implementations of the disclosure. It can be appreciated that the examples are intended primarily for purposes of illustration of the disclosure for those skilled in the art. There may be variations to these diagrams or the operations described herein without departing from the spirit of the disclosure. For instance, in certain cases, method steps or operations may be performed or executed in differing order, or operations may be added, deleted or modified.

What is claimed is:

1. An imaging system comprising:
a control system comprising a timing system and an image processing system;
one or more image sensors in electrical communication with the control system, wherein the one or more image sensors support data collection relative to a first pixel subwindow of a given image sensor; and
an optical assembly positioned between the one or more image sensors and a target, the optical assembly oriented to receive light from the target and direct the light to the image sensor; wherein the optical assembly has an imaging focal volume within the imaging environment that spans a range of focus;
the timing system in electrical communication with the one or more image sensors, an illumination system and a translation assembly, wherein translation assembly moves target in imaging environment, wherein the timing systems triggers the illumination system to illuminate the target, wherein the one or more sensors receive an image of the target, the first pixel subwindow aligned with at least a portion of the image of the target.

2. The system of claim 1, wherein image processing system synthesizes a 2D image from at least one frame exposure comprising image sensor pixel values readout from the one or more image sensors.

3. The system of claim 1 wherein the control system further comprises a control interface, wherein the control interface accepts user inputs to define a first pixel subwindow.

4. The system of claim 1 wherein the optical assembly is telecentric.

5. The system of claim 1 further comprising at least a second pixel subwindow wherein the optical assembly is configured to provide telecentric imaging of at least the imaging focal volume the pixel value processor synthesizes at least a second 2D image from image sensor pixel values in the second pixel subwindow.

6. The system of claim 2 wherein a plurality of frame exposures are acquired with respect to the target using the image system, wherein the pixel value processor synthesizes at least a first 2D image from a first subset of the frames and a second 2D image from a second subset of the frames, wherein the timing system coordinates frame exposures in response to motion of the target such that image sensor pixel values in the pixel subwindow align cyclically with pixels in each of the 2D images

7. The system of claim 6 wherein the timing system uses one or more of illumination, exposure, and translation parameters chosen for each of the 2D images.

8. The system of claim 1 further comprising a projection system comprising a projection focal volume such that the imaging focal volume and the projection focal volume overlap.

9. The system of claim 6 wherein the projection system projects a predetermined pattern uniquely encoding target height.

10. The system of claim 1 wherein the target provides light from a least one fluorescent label in response to a least one component wavelength of received light.

11. The system of claim 1, wherein targets range from 1 mm to about 10 mm along one or more dimensions, wherein targets are imaged while traveling at rate that ranges from about 10 mm/second to about 2000 mm/second.

12. The system of claim 1 further comprising one or more sensors arranged relative to target and in communication with the control system, wherein the one or more sensors measure changes in height of the target, wherein data from the one or more sensors is used to compensate for target height variations.

13. The system of claim 1, wherein optical assembly is positioned such that image plane relative to the target intersects a motion axis of the target.

14. The system of claim 1 further comprising an illumination system comprising an illumination source, the illumination system comprising one or more illumination system parameters.

15. The system of claim 14 wherein illumination system parameters are selected from a group consisting of duration, angular content, direction, shutter speed, polarization, coherence, and spectral content.

16. A method of imaging a target undergoing relative motion to a reference frame, the method comprising:
positioning an image sensor relative to the target and reference frame, wherein the image sensor generates image sensor pixel values, the target moving along a first axis;
specifying a pixel subwindow for the image sensor corresponding to a subset of image sensor pixel values;
positioning an imaging optical assembly having an image plane relative to the target such that the image plane intersects the first axis at an angle such the pixel subwindow is alignable with one or more of a plurality of regions in the reference frame transverse to the translation axis, wherein the plurality of regions corresponds to a focal height;
synchronizing illuminating and imaging of target with respect to the pixel subwindows, such that illumination and imaging occur when one or more of the plurality of regions align with the pixel subwindow; and
imaging portions of the target disposed in at least one of the regions as the target translates through said image plane and collecting image data with respect thereto.

17. The method of claim 16 further comprising parsing the image data into groups according to corresponding to pixel subwindow data and exposure conditions.

18. The method of claim 16 further comprising specifying different illumination schemes to expose at least one portion of the target with differing illumination schemes wherein the schemes comprise illumination parameters chosen from the group consisting of duration, angular content, direction, polarization, coherence, and spectral content.

19. The method of claim 16 further comprising collecting a plurality of synchronized image data at identical target locations and under identical exposure conditions during a single translation of the target.

20. The method of claim 19 further comprising assembling at least one 2D image from the synchronized image data.

21. The method of claim 16 further comprising combining subwindow data from each image data group to form a combined image of the target where each portion of the target is in focus.

22. The method of claim 21 wherein the combined image is a planarized image.

23. The method of claim 16 wherein the target is at least one object moving in a fluid flow channel and further comprising specifying a subpixel window for one or more positions along the flow channel.

24. The method of claim 16 further comprising combining subwindow data from each image data group to form a combined image wherein contrast of regions of interest having dissimilar optical properties are enhanced such that contrast of combined image does not change more than between about 5% and 10% across image.
